(19) United States
(12) Patent Application Publication
(10) Pub. No.: US 2002/0145015 A1
(43) Pub. Date: Oct. 10, 2002

(54) Caulking gun carriage

(76) Inventor: Gary W. Nelson, Reno, NV (US)

Correspondence Address: IAN F. BURNS, P O BOX 20038, RENO, NV, 89515, US

(21) Appl. No.: 10/090,186

(22) Filed: Feb. 25, 2002

Related U.S. Application Data
(60) Provisional application No. 60/272,488, filed on Feb. 28, 2001.

(51) Int. Cl. G01F 11/06; G01F 11/30

(52) U.S. Cl. 222/326; 222/327

(57) ABSTRACT

This specification discloses carriages for a caulking gun. The preferred carriage includes an integral central housing section preferably made of extruded aluminum. The integral central housing section preferably has co-extruded ribs or thickened sections, at least some of which most preferably provide continuously-formed fastener passages. The carriage preferably also has planar end plates secured to the integral central housing section by fasteners such as, most preferably, self-tapping screws. The screws penetrate associated passages in the end plates and in the ribs or other end structure of the central housing section. The carriage may be adapted to accommodate one, two, or more tubes of flowable material such as caulk, epoxy components, adhesive, etc.

### CROSS-REFERENCE TO RELATED APPLICATIONS

This application claims priority through the applicant's prior provisional U.S. patent application, entitled “Caulking Gun,” Ser. No. 60/272,488, filed Feb. 26, 2001.

### FIELD OF THE INVENTION

This invention relates to an improved carriage for a caulking gun. More particularly, this invention relates to a caulking gun carriage for holding tubes or containers from which flowable material is ejected through one end of the carriage.

### BACKGROUND

Caulking guns and their associated carriages are well known in the prior art and have been in widespread industrial and household use for many decades. In this specification, it is to be understood that the term “caulking gun” means a hand-held tool for ejecting any of a variety of flowable materials from a carriage on the gun. The carriage supports a removable and replaceable material tube containing flowable material to be ejected by the gun, and a drive rod penetrates the tube within the confines of the carriage to drive material from the tube by axial movement of the drive rod along the carriage axis toward the ejection end of the carriage. A given material tube may include one among a variety of differing types of materials or compositions of materials, such as conventional “caulk” or other types of flowable and tube-ejectable materials or compositions, such as, without limitation, glue, putty, or epoxy components.

Typically, caulking guns in the prior art have provided cylindrical tube carriages, such as shown in FIG. 1, or heavier and more rigid frame carriages, such as shown in FIG. 2. The heavier and more rigid frame carriage of FIG. 2 is often referred to as a “professional grade” carriage since it is adapted to last longer as well as withstand greater operating pressures for driving flowable materials through a material tube, or simultaneously through two material tubes when both are mounted in this type of carriage.

The conventional cylindrical carriage of FIG. 1 is lightweight, but it is also typically made from three components—two end caps and a central cylindrical section—all formed from pressed thin metal sheet. The end caps are typically spot welded to the central cylindrical section, which is a somewhat costly and time consuming manufacturing operation. The resulting cylindrical carriage has radial externally projecting, rounded thin walls for purposes of adding cylindrical stability to the central cylindrical section, but this prior art carriage is still quite weak overall and can easily be bent out of shape during use or when stepped upon, for example, in a work area. This prior art cylindrical carriage also is often insufficiently strong to withstand high material ejections pressures such as those required to dispense material from one or more material tubes in the professional environment in particular.

The professional grade prior art of FIG. 2 is much heavier and more expensive than the consumer grade cylindrical carriage of FIG. 1. This professional grade prior art is made of five steel components (two side bars, one drive end plate, and two mating ejection end plate) that are: (i) cut and formed; (ii) placed in position with respect to one another by means of dies, fixtures, or other equipment; (iii) welded together; and (iv) then powder coated to provide rust resistance. The FIG. 2 prior art carriage is therefore relatively heavy (up to two pounds in the case of the embodiment shown in FIG. 2), labor intensive and time consuming to manufacture, and relatively expensive. It is, in addition, generally easy to bend the side bars and difficult to repair if it is bent or broken.

The applicant has discovered that the professional grade carriage of FIG. 2 thus solved certain problems with the conventional cylindrical housing of FIG. 1 while presenting additional problems to those who manufacture or use the professional grade carriage of FIG. 2. As noted above, these problems include weight, labor and time for manufacture, cost, ease of being damaged, and difficulty of repair in general.

### BRIEF SUMMARY OF THE INVENTION

The applicant has invented an improved caulking tube carriage for use in a caulking gun having a drive rod movable along its axis within the carriage. The carriage has a central housing made of a rigid material, which is most preferably extruded to form the shape of the central housing.

The central housing extends between a drive end and a rigid ejection end having a caulking tube nozzle passage. Most preferably, the central housing consists of relatively lightweight and rust resistant aluminum or aluminum alloy.

Preferably, the central housing has an arcuate, relatively thin-walled cross-section. Preferably, the central housing also has a plurality of axially-extending, thickened, extruded sections or rounded ribs, each of which most preferably has fastener passages in its opposing ends.

Most preferably, a plurality of the fastener passages in the ribs are co-extruded, axially extending, arcuate-shaped, thin-walled sections formed in the wall of the central housing.

Most preferably, the drive end and ejection end are comprised of rigid plates abutting and secured to the central housing by fasteners (most preferably self-tapping screws) passing through the plates to penetrate the fastener passages in mating ends of the thickened sections or ribs in the central housing. Most preferably, the drive end and ejection end are planar and made of aluminum or steel.

Most preferably, the present improved carriage is relatively lightweight, strong and durable, rust resistant, relatively easy to use and repair, and/or economical to manufacture.

While the foregoing briefly summarizes aspects of the present invention, there are other aspects of the present invention that will become apparent as the specification proceeds. In this regard, it is to be understood that the actual scope of the invention is to be determined not by this brief summary but rather by reference to the accompanying claims and their equivalents as appropriate.

### DESCRIPTION OF THE DRAWINGS

Prior art and the preferred embodiments of the present invention are shown in the accompanying drawings wherein:

FIG. 1 is a perspective view of a conventional prior art cylindrical carriage for use in a conventional hand-held caulking gun;

FIG. 2 is a perspective view of a professional grade prior art caulking gun carriage for use in a professional-grade hand-held caulking gun;

FIG. 3 is a perspective view of a single tube embodiment of the applicant's improved tube carriage, providing an improved caulking gun in order to extrude flowable material or caulk from an associated removable tube containing the material or caulk;

FIG. 4 is a cross-sectional view of the applicant's single tube carriage taken along (partial) section line 4 in FIG. 3;

FIG. 5 is perspective view of a dual tube embodiment of the applicant's improved tube carriage;

FIG. 6 is a cross-sectional view of the applicant's dual tube carriage taken along section line 6-6 of FIG. 5;

FIG. 7 is a cross-sectional view of an alternative embodiment of the present extruded single tube carriage; and

FIG. 8 is a cross-sectional view of an alternative embodiment of the present extruded double tube carriage.

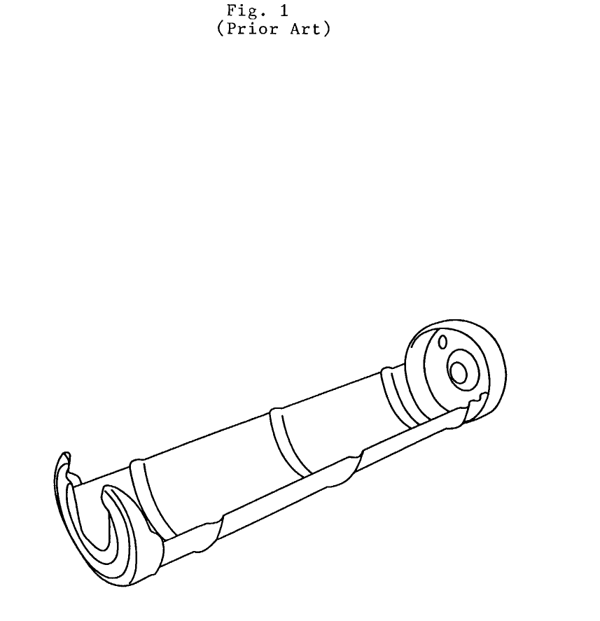

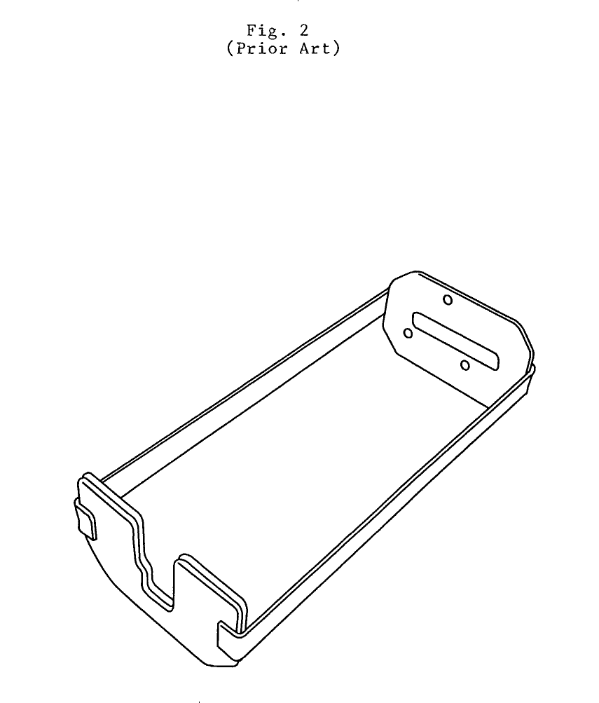

### DETAILED DESCRIPTION OF THE PREFERRED EMBODIMENT

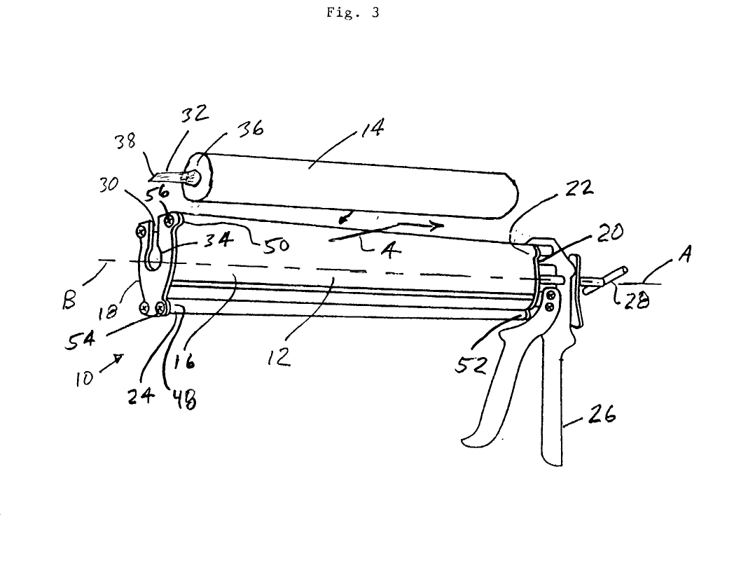

With reference now to FIG. 3, a caulking gun, generally 10, may include a single-tube embodiment of the present carriage 12 in order to support a caulking tube 14, which is removably insertable into the carriage 12. The carriage 12 has a central tube housing section 16, a planar ejection end plate 18, and a planar drive end plate 20. The central tube housing section has a first end 22 abutting the drive end plate 20 and a second end 24 abutting the ejection end plate 18.

Still referring to FIG. 3, a conventional caulking gun handle 26 is secured to the carriage 12, and a conventional drive rod 28 is mounted in the handle 26, all in a fashion well known to those skilled in the art. It is to be understood, however, that the present carriage may be secured instead to other types of handles and electric, air operated, or other drive mechanisms in a fashion well know to those skilled in the art.

Still referring to FIG. 3, the drive rod 28 slidably penetrates a drive rod passage (not shown in FIG. 3) in the drive end plate 20. The drive rod 28 is thereby slidably mounted within the carriage 12 and its central tube housing section 16 so that the axis A of the drive rod 20 is movable axially along the axis B of central tube housing 12, which axis B is coaxial with the drive rod axis A. A transverse drive rod pusher plate (not shown) is secured to the drive end (not shown) of the drive rod 28 within the interior of the central tube housing 12. In this manner, upon driving actuation of the handle 26 (or other drive means as noted above), the press plate slidably engages a slidable piston (not shown) within the caulk tube 14 in order to drive the press plate along the axial length of the caulk tube 14—all in a fashion well known to those skilled in the art.

The ejection end plate 18 of the present carriage 12 has a caulk tube nozzle slot or passage 30. A narrower caulk ejection nozzle 32 on the larger caulk tube 14 is thereby slidably and removably mounted within the support passage 30, and the support passage 30 thereby provides a neck or nozzle stop 34 abutting the transverse ejection end 36 of the caulk tube 14 when mounted within the carriage 12 in a fashion well known to those skilled in the art. Thus, as the drive rod 28 is actuated by an operator (not shown) to drive the press plate on the drive rod toward the ejection end 36 of the caulk tube 14, the neck stop 34 restrains the caulk tube 14 from movement with respect to its position in the carriage 12 and caulk or other flowable material within the tube 14 is ejected out an ejection or nozzle port 38 in the caulk ejection nozzle 32 extending axially outwardly from the nozzle stop 34 and associated nozzle passage 30 in the carriage ejection plate 18.

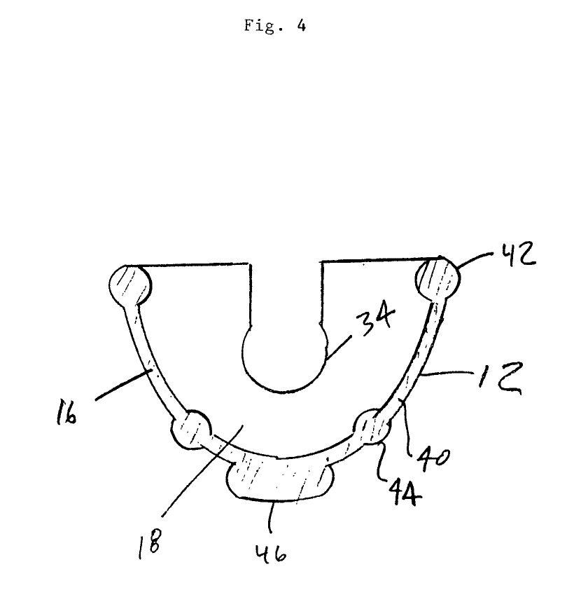

Referring now to FIG. 4, the central housing section 16 consists of extruded rigid material—preferably an economical, lightweight, and rust resistant material such as aluminum or aluminum alloy. The central housing section 16 generally has an arcuate, relatively thin-walled cross-section 14. It is to be understood, in this regard, that the term “acuate” as used herein means arc-shaped, U-shaped, cup-shaped, V-shaped, and other caulk tube-cradling or surrounding shape. In the most preferred embodiment, the thin-walled cross-section is 0.020 to 0.250 inches thick at the location of numeral 40 in FIG. 4 and throughout the majority of the cross-section 14 of the central housing section 16.

In the preferred embodiment, the central housing section 16 also includes extruded, axially-extending thickened ribs, e.g., 42, 44, 46. The ribs, 42, 44 preferably have, as shown, a rounded external periphery and provide additional bending strength to the central housing 16.

As shown in FIG. 3, the rib ends, e.g., 48, 50, 52, have axially extending housing screw passages (not shown) pre-drilled or otherwise pre-formed within them. Mating screw passages (not shown) axially penetrate the drive end plate 20 and the ejection end plate 18; and rust-resistant stainless steel or zinc screws, e.g., 54, 56, 58 (not shown), penetrate the mating screw passages in order to lockingly thread into mating housing screw passages in the rib ends, e.g., 48, 50, 52.

The planar drive end plate 20 and ejection end plate 18 are preferably made of rust-resistant, lightweight, and strong metals such as aluminum and steel. The entire preferred single tune carriage 12 for a standard caulking tube thus weighs approximately 30 to 32 ounces.

The carriage 12 can be manufactured quite economically without any welding or powder coating steps and with few metal forming steps. With regard to the embodiment shown in FIG. 4, the manufacturing steps consist of: (i) extruding and cutting to size the central housing section 16; (ii) drilling fastener passages in the rib ends, e.g., 48, 50, 52, in the central housing section 16; (iii) stamping the drive end plate 20 and the ejection end plate 18; and (iv) securing the drive end plate 20 and ejection end plate 18 to the central housing section 16 with self-tapping screws, e.g., 54, 56, 58.

Although the preferred embodiment of the carriage 12 has a completely integral extruded central housing section 16, the central housing section 16 alternatively could be integrally formed of stamped metal such as a steel alloy or stainless steel. The resulting carriage 12 would be quite strong and resistant to bending. If made out of stamped steel, however, the carriage 12 would be significantly heavier and more costly to make than the extruded aluminum central housing section 16 describe above.

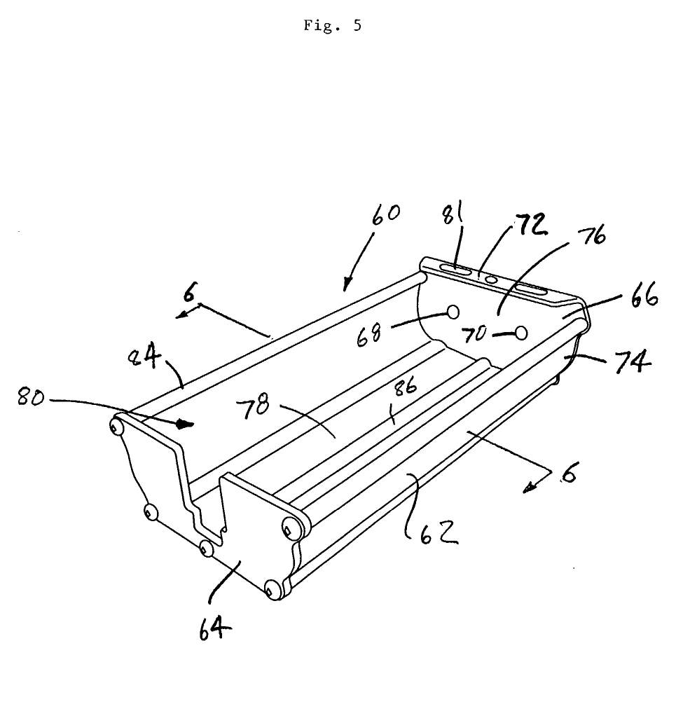

Referring now to the FIG. 5, the preferred dual tube carriage 60 also preferably has an integral or unitary central housing section 62 extending axially between and securely abutting a mating drive end plate 66 and ejection end plate 64. The central housing section 62 is most preferably made of extruded aluminum but could be made of pressed, rigid material such as steel, steel alloy, or stainless steel. The drive end plate 66 and ejection end plate 64 are preferably made of aluminum or mild steel.

The drive end plate 66 has two axially-extending drive rod passages 68, 70. The drive end plate 66 also has a somewhat transverse bent arm section or lip 72 extending axially inwardly from the extrusion end 74 of the central housing section 62 toward the ejection end plate 64. The generally transverse bent arm section 72 renders the drive end plate 66 stiffer and less likely to bend when subjected to the substantial forces of two caulk-type tubes, such as mating epoxy tubes, against the interior surface 76 of the drive plate 66 during use of the carriage 60 in a caulking gun (not shown in FIG. 5). The bent arm section 72 also serves to retain mounted caulk tubes in position in the carriage 60 and from moving away from the supporting central housing base 78 toward or through the tube mounting opening 80 The bent arm section 72 may have cut-out sections, e.g., 81, in order to reduce the weight of, and provide viewing windows in, the drive end plate 66 without unduly weakening the bent arm section 72 from providing sufficient bending strength for the plate 66.

It should be understood that the bent arm configuration of the drive end plate 66 could be included if desired on, as shown in FIGS. 3 and 4, the end plate 20 of the single tube embodiment. Referring back to FIG. 5, other transversely stiffening or strengthening structure could be added to, or substituted on, the drive end plate 66 in order to prevent the plate 66 from bending in use and/or to prevent the tube cartridge from moving outwardly from the housing 62.

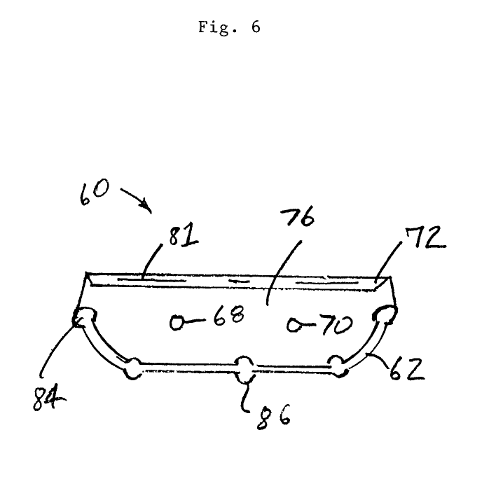

With reference now to FIG. 6, the central housing section 62 of the preferred dual tube embodiment also has an arcuate cross-section 82. The cross-section 82 of the central housing section 62 is generally thin-walled with five integrally-extruded axially extending ribs or thickened sections, e.g., 84, 86.

Referring now to both FIGS. 5 and 6, the most preferred embodiment of the dual tube carriage 60, weighs from 3 ounces, for standard-sized caulk tubes, to about 24 ounces for over-sized caulk tubes.

Like the single tube embodiment described above, the dual tube embodiment 60 is thus rust resistant, strong, and durable, yet relatively lightweight as well as economical and relatively easy to manufacture. Both embodiments provide a professional grade carriage but at a reasonable cost. Both embodiments are also relatively easily repairable, such as by replacement of a damaged central housing section, drive end plate, or ejection end plate by merely removing the associated fasteners, replacing or repairing the damaged element, and re-assembling the components with the removed or other fasteners.

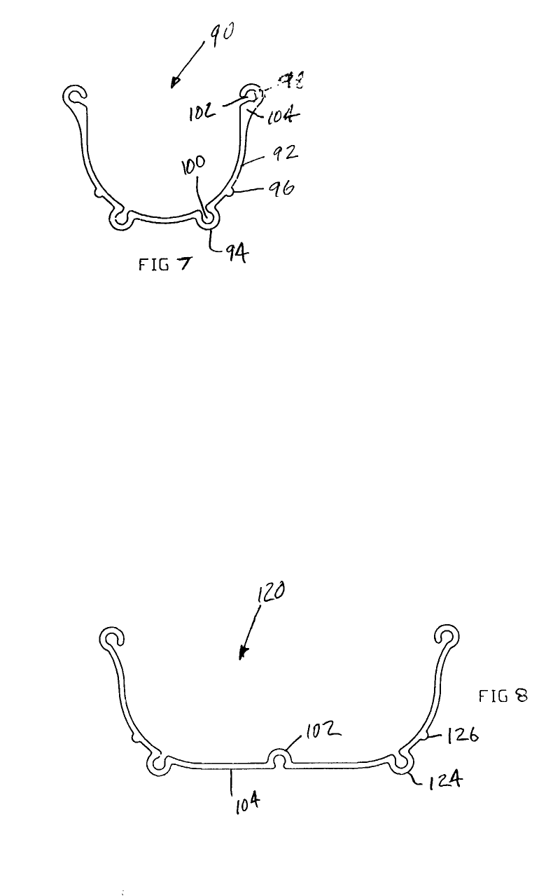

With reference now to FIG. 7, an alternative embodiment 90 to the carriage housing of FIG. 4 is made of extruded aluminum and has a generally thin-walled, arcuate cross-section 92. Co-extruded in the housing 90 are internal rib sections, e.g., 94, 96, 98. These ribs 94, 96, 98 extend along the axial length of the housing 90, and a plurality of the ribs, e.g., 94, 98, include co-extruded, most preferably dominantly tubular or cylindrical passages 100, 102. These co-extruded passages 100, 102 provide fastener passages pre-formed in the extruded housing 92 for receipt of self-tapping fasteners or screws (not shown in FIG. 7) in order to secure end plates (not shown in FIG. 7) to the housing 90. Other co-extruded ribs, e.g., 96, provide a generally thickened cross-section with respect to the thin-wall cross-section 92 of the housing generally 90. Other axially-extending, co-extruded, thickened sections, e.g., 104, may also be provided in the housing 90. These ribs, e.g., 94, 96, 98, and thickened sections, e.g., 104, collectively can provide additional rigidity and durability to the housing 90, while simultaneously reducing the weight and cost of the housing 90 by utilizing less material to form the ribs that have co-extruded passages within them, e.g., 94, 98. With this structure, the housing 90 may be continuously extruded and completely formed, including with the continuously formed fastener passages 64, 98; and multiple housings may be formed from one extrusion cut into housing sections of the desired axial length for the housing as desired.

With reference now to FIG. 8, an alternative embodiment 120 to the double tube carriage of FIG. 6 is constructed similarly to the alternative single tube embodiment of FIG. 7 above. As shown in FIG. 8, one or more of the ribs, e.g., 22, may be formed to protrude radially inwardly from the housing periphery 104 rather than radially outwardly as in the case of other ribs, e.g., 124, 126. This same arrangement can be provided in the single tube structure of FIG. 7 or FIG. 4 if desired.

It is to be understood that, in the foregoing section, the applicant has described the preferred embodiments in detail. It is to be understood, however, that the scope of the present invention is to be determined by the following claims, including all appropriate equivalents.

What is claimed is:

1. An improved caulking gun carriage of the type usable in a hand-held caulking gun having a drive rod penetrating a tube carriage so that a user may activate the drive rod to eject a flowable material from a flowable material tube removably supported in the tube carriage; the improved caulking gun carriage comprising:
A carriage body extending axially between and secured to a first end cap and a second end cap, said carriage body consisting predominantly of an extruded rigid material having an arcuate cross-section perpendicular to the axis of the carriage body.

2. The improved caulking gun carriage of claim 1 wherein the carriage body also has co-extruded thickened sections extending the axial length of the carriage body.

3. The improved caulking gun carriage of claim 2 wherein: (i) at least one of the thickened sections include a co-extruded, axially extending, arcuate passage; and (ii) each of the end caps is secured to the carriage body by at least one fastener passage in said end cap to penetrate the arcuate passage in the thickened sections in the carriage body.

4. The improved caulking gun carriage of claim 2 wherein the each of the end caps is secured to the carriage body by screws passing through screw passages in said end cap to penetrate said co-extruded thickened sections in the substantially arcuate cross-section of the carriage body.

5. The improved caulking gun carriage of claim 2 wherein the co-extruded thickened sections each have a substantially arcuate cross-section perpendicular to the axial length of the carriage body.

6. The improved caulking gun carriage of claim 4 wherein the co-extruded thickened sections each have a substantially arcuate cross-section perpendicular to the axial length of the carriage body.

7. The improved caulking gun carriage of claim 1 wherein the extruded rigid material consists essentially of a lightweight, durable metal such as aluminum or aluminum alloy.

8. The improved caulking gun carriage of claim 2 wherein the extruded rigid material consists essentially of a lightweight, durable metal such as aluminum or aluminum alloy.

9. The improved caulking gun carriage of claim 3 wherein the extruded rigid material consists essentially of a lightweight, durable metal such as aluminum or aluminum alloy.

10. The improved caulking gun carriage of claim 4 wherein the extruded rigid material consists essentially of a lightweight, durable metal such as aluminum or aluminum alloy.

11. The improved caulking gun carriage of claim 5 wherein the extruded rigid material consists essentially of a lightweight, durable metal such as aluminum or aluminum alloy.

12. The improved caulking gun carriage of claim 6 wherein the extruded rigid material consists essentially of a lightweight, durable metal such as aluminum or aluminum alloy.

13. A caulking gun carriage of the type used in a manually-operated caulking gun having a at least one drive rod movably mounted in the carriage for axial movement of the drive rod to eject a flowable material from at least one material ejection tube removably mounted in the carriage, the caulking gun carriage comprising:
An extruded ejection tube housing having a substantially arcuate cross-section, a rigid drive end, and a rigid ejection end with at least one ejection tube passage in the ejection end, the extruded ejection tube housing extending between the opposing drive end and ejection end in the caulking gun carriage, whereby at least one material ejection tube may be removably mounted in the extruded ejection tube housing to eject flowable material through the ejection tube passage in the ejection tube carriage.

14. The caulking gun carriage of claim 13 wherein the ejection end of the caulking tube carriage includes a multi-tube support for at least a first and a second ejection tube, whereby at least two material ejection tubes may be mounted in the extruded ejection tube housing in order to eject flowable material from said first and second ejection tubes respectively through said first and second ejection tube passages.

15. The caulking gun carriage of claim 13 wherein the extruded ejection tube housing has at least one thickened extruded rib integral to, and extending axially along, the extruded ejection tube housing.

16. The caulking gun carriage of claim 14 wherein the extruded ejection tube housing has at least one thickened extruded rib integral to, and extending axially along, the extruded ejection tube housing.

17. The caulking gun carriage of claim 13 wherein the extruded ejection tube housing consists essentially of a lightweight, rust resistant, rigid material such as aluminum or aluminum alloy.

18. The caulking gun carriage of claim 14 wherein the extruded ejection tube housing consists essentially of a lightweight, rust resistant, rigid material such as aluminum or aluminum alloy.

19. The caulking gun carriage of claim 15 wherein the extruded ejection tube housing consists essentially of a relatively lightweight, rust resistant, rigid material such as aluminum or aluminum alloy.

20. The caulking gun carriage of claim 16 wherein the extruded ejection tube housing consists essentially of a relatively lightweight, rust resistant, rigid material such as aluminum.

21. The caulking gun carriage of claim 15 wherein: (i) the ejection end of the ejection tube housing has a plurality of fastener passages, (ii) the extruded ejection tube housing has a plurality of said thickened extruded ribs extending along the entire axial length of the extruded ejection tube housing and having a plurality of rib fastener passages axially penetrating the rib, and (iii) the caulking gun carriage further comprises a plurality of ejection end fasteners, each of said ejection end fasteners passing through one among the plurality of ejection end fastener passages to penetrate an associated one among the plurality of rib fastener passages.

22. The caulking gun carriage of claim 16 wherein: (i) the ejection end of the ejection tube housing has a plurality of fastener passages, (ii) the extruded ejection tube housing has a plurality of said thickened extruded ribs extending along the entire axial length of the extruded ejection tube housing and having a plurality of rib fastener passages axially penetrating the rib, and (iii) the caulking gun carriage further comprises a plurality of ejection end fasteners, each of said ejection end fasteners passing through one among the plurality of ejection end fastener passages to penetrate an associated one among the plurality of rib fastener passages.

23. The caulking gun carriage of claim 18 wherein: (i) the ejection end of the ejection tube housing has a plurality of fastener passages, (ii) the extruded ejection tube housing has a plurality of said thickened extruded ribs extending along the entire axial length of the extruded ejection tube housing and having a plurality of rib fastener passages axially penetrating the rib, and (iii) the caulking gun carriage further comprises a plurality of ejection end fasteners, each of said ejection end fasteners passing through one among the plurality of ejection end fastener passages to penetrate an associated one among the plurality of rib fastener passages.

24. The caulking gun carriage of claim 19 wherein: (i) the ejection end of the ejection tube housing has a plurality of fastener passages, (ii) the extruded ejection tube housing has a plurality of said thickened extruded ribs extending along the entire axial length of the extruded ejection tube housing and having a plurality of rib fastener passages axially penetrating the rib, and (iii) the caulking gun carriage further comprises a plurality of ejection end fasteners, each of said ejection end fasteners passing through one among the plurality of ejection end fastener passages to penetrate an associated one among the plurality of rib fastener passages.

25. The caulking gun carriage of claim 24 wherein the drive end and the ejection end of the ejection tube carriage each comprise a rigid plate.

26. The caulking gun carriage of claim 25 wherein the drive end and the ejection end of the ejection tube each comprise a planar rigid plate.

27. A caulking gun carriage of the type having at least one drive rod movably mounted in the carriage for axial movement of the drive rod along the axial length of the carriage toward and away from the ejection end in order to eject a flowable material from a material ejection tube removably mounted in the carriage, the caulking gun carriage comprising in combination:
A rigid, unitary ejection tube housing, a drive end, and an ejection end with at least one ejection tube passage in the ejection end, the ejection tube housing having a substantially thin-walled, arcuate cross-section and extending between, and secured to, the opposing drive end and ejection end in the caulking gun carriage;
whereby at least one material ejection tube may be removably mounted in the ejection tube housing to abut the ejection end, and eject flowable material through the ejection tube passage, in the caulking gun carriage.

28. The caulking gun carriage of claim 28 wherein the ejection tube housing also has thickened sections extending along the axial length of the ejection tube housing and terminating adjacent at least one among the ejection end and drive end of the ejection tube carriage, the arcuate cross-section thereby also having thin-thick-thin cross-sectional configurations.

29. The caulking gun carriage of claim 28 wherein the ejection tube carriage is made of a rust resistant, lightweight metal such as aluminum or aluminum alloy.
